(19) United States
(12) Patent Application Publication
(10) Pub. No.: US 2015/0319666 A1
(43) Pub. Date: Nov. 5, 2015

(54) METHOD AND APPARATUS FOR FAST HANDOVER EVALUATION

(71) Applicant: QUALCOMM Incorporated, San Diego, CA (US)

(72) Inventors: Insung KANG, San Diego, CA (US); Jie MAO, Beijing (CN); Aamod Dinkar KHANDEKAR, San Diego, CA (US); Hari SANKAR, San Diego, CA (US); Qiang SHEN, San Diego, CA (US); Chao JIN, San Diego, CA (US); Song TIAN, Beijing (CN); Shiau-He TSAI, San Diego, CA (US); Qingxin CHEN, Del Mar, CA (US); Huichun CHEN, Beijing (CN)

(21) Appl. No.: 14/648,216

(22) PCT Filed: Sep. 18, 2013
(86) PCT No.: PCT/CN2013/083744

§ 371 Date: May 28, 2015

(30) Foreign Application Priority Data
Jan. 11, 2013 (CN) PCT/CN2013/070371

(51) Int. Cl. H04W 36/30; H04W 36/00; H04W 72/04; H04W 24/10

(52) U.S. Cl. CPC H04W 36/30; H04W 24/10; H04W 36/0005; H04W 72/0406; H04W 88/02

(57) ABSTRACT

Methods and apparatus for wireless communication for improving handover between a network and a user equipment (UE) when a measurement report is received. Aspects of the methods and apparatus relate to determining the quality of a serving cell associated with a fast handover performance threshold. When the fast handover performance threshold is breached, the UE may transmit a measurement report requesting a handover to a target cell. Upon requesting a handover to a target cell when the fast handover performance threshold is breached, the UE receives a handover trigger allowing handover to a target cell.

### CLAIM OF PRIORITY UNDER 35 U.S.C §119

The present Application for Patent claims priority to PCT Application No. PCT/CN/2013/070371 entitled “METHOD AND APPARATUS FOR FAST HANDOVER EVALUATION” filed Jan. 11, 2013, in the Receiving Office of China (RO/CN), and assigned to the assignee hereof and hereby expressly incorporated by reference herein.

### BACKGROUND

1. Field

Aspects of the present disclosure relate generally to wireless communication systems, and more particularly, to an apparatus and method for improving handover between a network and a user equipment (UE).

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

In current TD-SCDMA system, handover (HO) can be initiated by network based on the measurement report message sent from a UE. The network can then initiate a HO to the target cell based on the measurement report. However, the UE will only generate the event and report the measurement report to a network when, for example, the target cell receive power is higher than receive power serving cell plus the hysteresis and after a time duration. These requirements may cause UE to drop the current call.

Thus, aspects of this apparatus and method include improving handover between a network and a UE when a measurement report is received.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Methods and apparatus for wireless communication for improving handover between a network and a user equipment (UE) when a measurement report is received. Aspects of the methods and apparatus relate to determining the quality of a serving cell associated with a fast handover performance threshold. When the fast handover performance threshold is breached, the UE may transmit a measurement report requesting a handover to a target cell. Upon requesting a handover to a target cell when the fast handover performance threshold is breached, the UE receives a handover trigger allowing handover to a target cell.

In an aspect, a method for improving handover between a network and a UE is provided. The method includes determining the quality of a serving cell relative to a fast handover performance threshold. Additionally, the method includes transmitting a measurement report when the fast handover performance threshold is breached and requesting a handover to a target cell when the fast handover performance threshold is breached. Further, the method includes receiving a handover trigger based on the measurement report and based on the request for handover.

In another aspect, an apparatus for improving handover between a network and a UE is provided. The apparatus includes a processor configured to determine the quality of a serving cell relative to a fast handover performance threshold. Additionally, the processor is configured to transmit a measurement report when the fast handover performance threshold is breached and request a handover to a target cell when the fast handover performance threshold is breached. Further, the processor is configured to receive a handover trigger based on the measurement report and based on the request for handover.

In another aspect, an apparatus for improving handover between a network and a UE is provided that includes means for determining the quality of a serving cell relative to a fast handover performance threshold. Additionally, the apparatus includes means for transmitting a measurement report when the fast handover performance threshold is breached and means for requesting a handover to a target cell when the fast handover performance threshold is breached. Further, the apparatus includes means for receiving a handover trigger based on the measurement report and based on the request for handover.

In yet another aspect, a computer-readable media for improving handover between a network and a UE is provided that includes machine-executable code for determining the quality of a serving cell relative to a fast handover performance threshold. Additionally, the code may be executable for transmitting a measurement report when the fast handover performance threshold is breached and requesting a handover to a target cell when the fast handover performance threshold is breached. Further, the code may be executable for receiving a handover trigger based on the measurement report and based on the request for handover.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a schematic diagram illustrating an example aspect of call processing in a wireless communication system;

FIG. 2 is a schematic diagram illustrating another example aspect of call processing in a wireless communication system;

FIGS. 3-4 are schematic diagrams illustrating a graphical representation of call processing in the wireless communication system of the present disclosure;

FIG. 5 is a flow diagram illustrating an exemplary method for call processing in the wireless communication system of the present disclosure;

FIG. 6 is a block diagram illustrating additional example components of an aspect of a computer device having a call processing component according to the present disclosure;

FIG. 7 is a block diagram illustrating an example of a hardware implementation for an apparatus employing a processing system to perform the functions described herein;

FIG. 8 is a block diagram conceptually illustrating an example of a telecommunications system including a UE configured to perform the functions described herein;

FIG. 9 is a conceptual diagram illustrating an example of an access network for use with a UE configured to perform the functions described herein;

FIG. 10 is a conceptual diagram illustrating an example of a radio protocol architecture for the user and control planes for a base station and/or a UE configured to perform the functions described herein;

FIG. 11 is a block diagram conceptually illustrating an example of a Node B in communication with a UE in a telecommunications system configured to perform the functions described herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

As discussed above, in current TD-SCDMA systems, HO can be initiated by network based on the measurement report message sent from a UE. The UE measures the quality of a serving cell and/or a target cell and evaluates if an event report criterion is met. If the criterion is met, the UE will send the measurement report message including the event to a network. The network can then initiate a HO to the target cell based on the measurement report.

To mitigate a ping-pong effect (i.e., multiple handovers going back and forth between cells), a hysteresis and a timer with a predetermined value are used when the UE evaluates if a measurement report will be generated. Note, the predetermined value may be referred to as a “time to trigger” and the timer may be referred to as a “time to trigger timer.” However, the UE will only generate the event (i.e., an event that causes the UE to report a measurement report to network) when, for example, the target cell received power is higher than a sum of the received power of the serving cell plus a hysteresis value for a time duration. In this case, the value of the time duration is the “time to trigger.”

However, in some scenarios, the serving cell power drops too quickly and the connection may drop before the “time to trigger” timer expires and thus before the UE reports the measurement report to the network. Those scenarios can be, for example, when the UE goes into a building from outdoor coverage, or goes into a lift or elevator where there is only 2G coverage, or when the UE is on a high speed train. In this case, call can drop due to inability to report the link quality change before “time to trigger” timer expires.

However, as provided by the apparatus and methods described herein, if a UE can handover immediately to another cell (with possibly different time slot/frequency allocation) in the same Radio Access Technology (RAT) or to another cell in different RAT, the call can be saved.

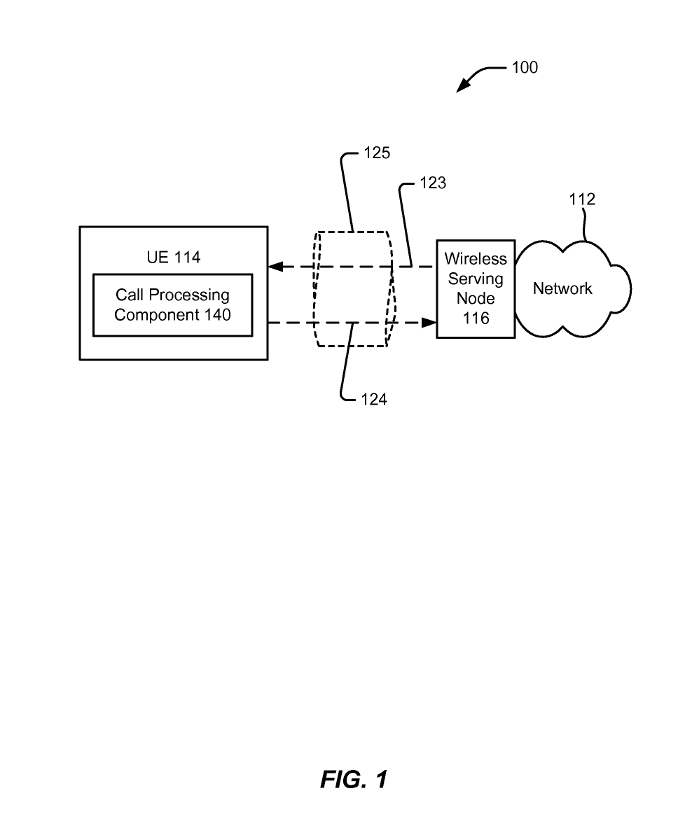

Referring to FIG. 1, in one aspect, a wireless communication system 100 is configured to facilitate transmitting vast amount of data from a mobile device to a network. Wireless communication system 100 includes at least one UE 114 that may communicate wirelessly with one or more network 112 via serving nodes, including, but not limited to, wireless serving node 116 over one or more wireless link 125. The one or more wireless link 125, may include, but are not limited to, signaling radio bearers and/or data radio bearers. Wireless serving node 116 may be configured to transmit one or more signals 123 to UE 114 over the one or more wireless link 125, and/or UE 114 may transmit one or more signals 124 to wireless serving node 116. In an aspect, signal 123 and signal 124 may include, but are not limited to, one or more messages, such as transmitting a data from the UE 114 to the network via wireless serving node 116.

In an aspect, UE 114 may include a call processing component 140, which may be configured to transmit a data to the wireless serving node 116 over wireless link 125. Specifically, in an aspect, call processing component 140 of UE 114 specified here may operate at the Packet Data Convergence Protocol (PDCP) layer of 3GPP systems and may operate operated at higher or lower layers of the network stack.

UE 114 may comprise a mobile apparatus and may be referred to as such throughout the present disclosure. Such a mobile apparatus or UE 114 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology.

Additionally, the one or more wireless nodes, including, but not limited to, wireless serving node 116 of wireless communication system 100, may include one or more of any type of network component, such as an access point, including a base station or node B, a relay, a peer-to-peer device, an authentication, authorization and accounting (AAA) server, a mobile switching center (MSC), a radio network controller (RNC), etc. In a further aspect, the one or more wireless serving nodes of wireless communication system 100 may include one or more small base stations, such as, but not limited to a femtocell, picocell, microcell, or any other small base station.

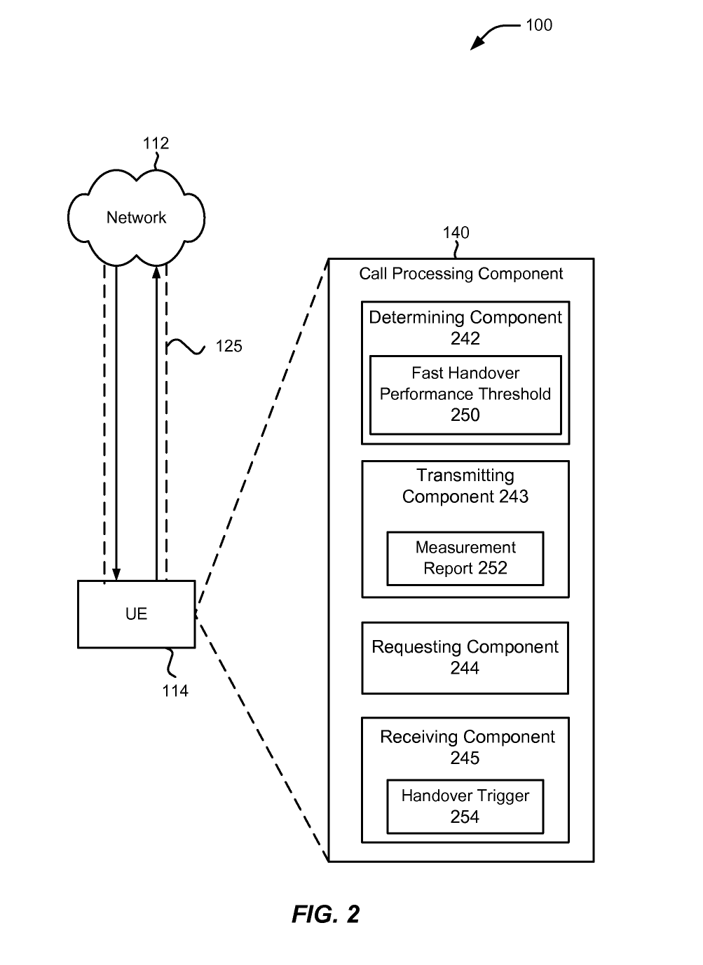

Referring to FIG. 2, in one aspect of the present apparatus and method, a wireless communication system 100 is configured to include wireless communications between network 112 and UE 114. The wireless communications system may be configured to support communications between a number of users. FIG. 2 illustrates a manner in which network 112 communicates with UE 114. The wireless communication system 100 can be configured for downlink message transmission or uplink message transmission over wireless link 125, as represented by the up/down arrows between network 112 and UE 114.

In an aspect, within the UE 114 resides a call processing component 140. The call processing component 140 may be configured, among other things, to include a determining component 242 capable of determining the quality of a serving cell relative to a fast handover performance threshold. For example, determining component 242, residing in the call processing component 140 of UE 114, is configured for determining the quality of a serving cell relative to a fast handover performance threshold 250.

The fast handover performance threshold 250 may be based on abrupt call quality variations during a time to trigger (TTT) period. For instance, the fast handover performance threshold 250 may include, but is not limited to, one or more of a threshold related to a signal quality metric (i.e., the average receiver signal to interference ratio (SIR), average block error rate (BLER), SIR target for the closed loop power control), a path loss based metric (i.e., received signal code power (RSCP)), an interference based metric (i.e., signal interference of neighboring cells), or a transmission power based metric (i.e., uplink power based metric).

In another aspect, the call processing component 140 may be configured to include a transmitting component 243 configured for transmitting a measurement report to a network entity when the fast handover performance threshold is breached. For example, transmitting component 243 is configured for transmitting a measurement report 252 to network 112 when the fast handover performance threshold 250 is breached.

It should be noted that the measurement report 252 may include information relating to the measured quality of the serving cell and/or one or more target cells.

In another aspect, the call processing component 140 may be configured to include a requesting component 244 capable of requesting a handover to a target cell when the fast handover performance threshold is breached. For example, requesting component 244 is configured for requesting a handover to a target cell when the fast handover performance threshold 250 is breached.

In yet another aspect, the call processing component 140 may be configured to include a receiving component 245 capable of receiving a handover trigger by a network entity based on the measurement report and based on the request for handover. For example, receiving component 245 is configured for receiving a handover trigger 254 from network 112 based on measurement report 252 and based on the request for handover requested by requesting component 244. In other words, receiving component 245 is operable to receive a handover trigger 254 from network 112 based on the measurement report 252 and the request for handover, wherein the handover trigger 254 instructs the UE 114 to perform a handover of a call to the target cell from the serving cell.

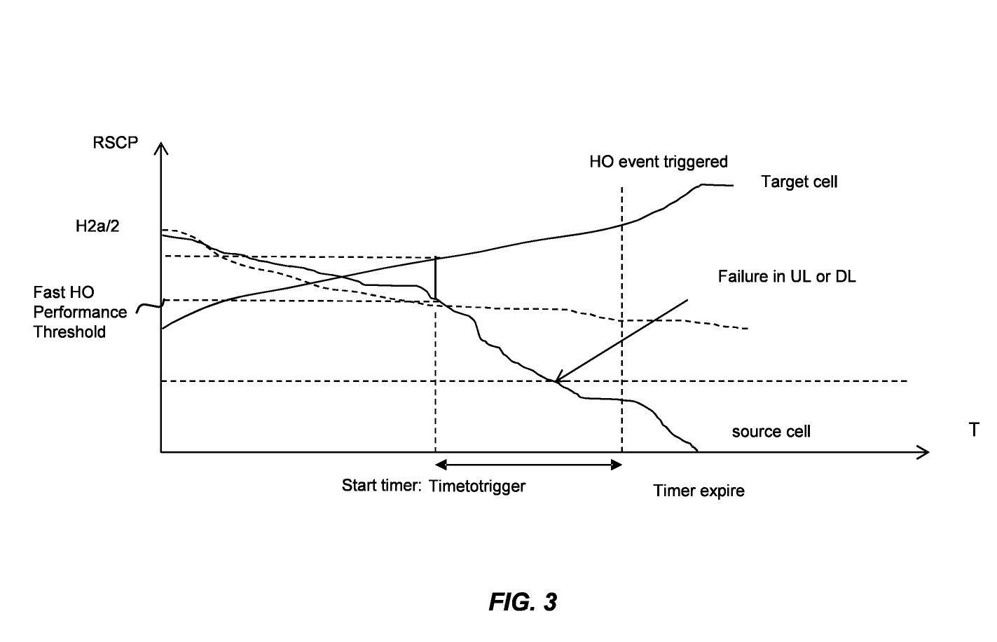

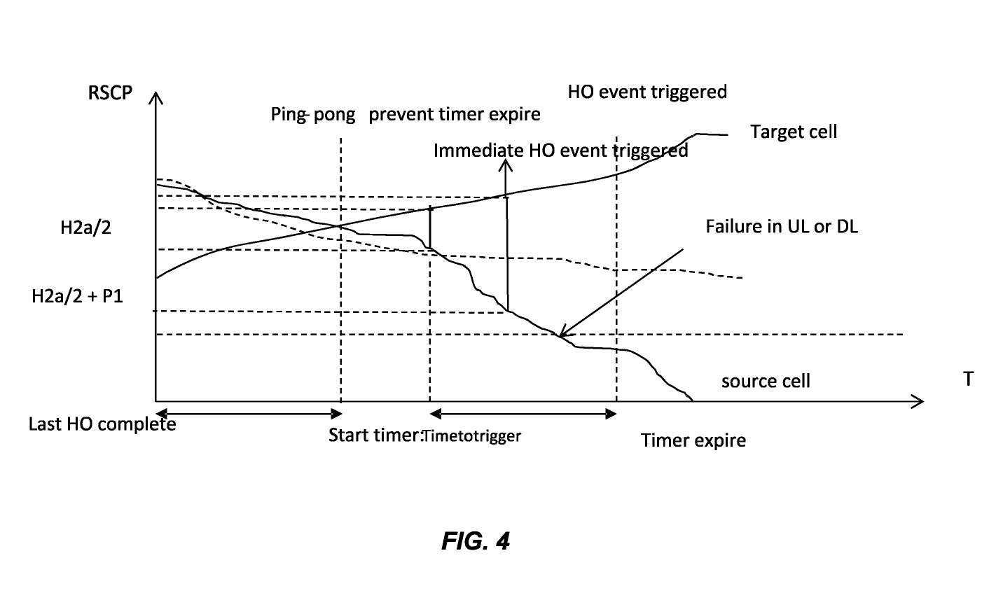

FIGS. 3-4 are schematic diagrams illustrating a graphical representation of call processing in the wireless communication system of the present disclosure. Specifically, FIG. 3 illustrates when a radio network control (RNC) handover is triggered when the quality of service of a source decreases rapidly. For example, when UE 114 is transported into a building or other enclosed structure, the path loss to source cell (serving cell) increases rapidly and received signal code power (RSCP) decreases. Furthermore, the path loss to a target cell decreases rapidly and RSCP increases. At this point, UE 114 may not be able to send measurement report to network 112 or fail to receive handover commands from network 112 and the call drops.

This can readily be seen in FIG. 3, where the RSCP of target cell is inversely proportionate to the RSCP of the source cell. Indeed, in order for trigger a HO event before the RSCP of the source cell decreases below a call failure threshold (i.e., the failure in uplink or downlink of the source cell, as disclosed in FIG. 3), the HO event must be triggered when the RSCP of the source cell breaches a higher threshold (i.e., the fast HO performance threshold, as disclosed in FIG. 3) than the call failure threshold.

In an aspect, to tackle the serving cell receiver RSCP fast drop problem without impacting other UEs in the same cell, the present apparatus and methods may include a new extra performance offset value on top of the hysteresis value to be added by the call processing component 140, as described with reference to FIG. 4. For example, within a time duration, e.g. the TTT, if the value of the quality of a target cell minus the quality of the serving cell increases from a hysteresis value to a hysteresis value plus the performance offset value (H2a/2+P1), e.g. one aspect of the fast handover performance threshold 250 as used herein, UE 114 will trigger a measurement event, e.g. reporting the measurement report to the network 112, immediately even if the “time to trigger” timer has not expired (i.e., the immediate HO trigger, as disclosed in FIG. 4). In other words, if the quality of the target cell is better than quality of the serving cell and the quality of target cell increases fast or the quality of serving cell drops fast, then the measurement event will be triggered immediately.

In another aspect, the faster the serving cell quality drops (or the target cell quality increases), the faster the measurement event report will be triggered. In other words, the measurement event report will be triggered based on a velocity of decrease in the RSCP of the serving cell. This will decrease the probability of a call drop in the fast serving cell quality drop scenario. Nonetheless, the likelihood of ping-pong handover can be mitigated by a proper performance offset value, where the quality of target cell minus the quality of serving cell should not reach the hysteresis value plus the performance offset value, e.g., one aspect of the fast handover performance threshold 250 as used herein, within the time to trigger duration, in normal scenarios.

For the interference scenarios, the present apparatus and methods may add other triggers (i.e., performance threshold breaches) for the fast HO event triggering, for instance, a trigger or performance threshold breach relating to a signal-to-interference ratio target (SIRtarget), which may be used for controlling transmitter power allocated to the receiver. For example, if there is interference UE 114 cannot handle, then the downlink block error rate (BLER) will increase and the outer loop power control will increase the SIRtarget. If the SIRtarget of the outer loop power control reaches a threshold, e.g., one aspect of the fast handover performance threshold 250 as used herein, then the present apparatus and methods can trigger the fast HO event.

Another example for improved HO involves received power from other cells in the time slot the UE is allocated. If the time slot received power from the other cells is much higher than the time slot receive power of the serving cell, e.g. greater than a threshold in one aspect of the fast handover performance threshold 250 as used herein, then the present apparatus and methods can trigger the fast HO event (i.e., the immediate HO trigger, as disclosed in FIG. 4).

Another example for improved HO involves uplink transmit power. If the uplink transmit power is higher than a threshold, e.g., one aspect of the fast handover performance threshold 250 as used herein, it can be interpreted that the network has interference from other UEs in uplink or the path loss is too high. In this case, the present apparatus and methods can trigger the fast HO event (i.e., the immediate HO trigger, as disclosed in FIG. 4). Further, to prevent ping-pong HO in the fast HO scenario, the present apparatus and methods may add a ping-pong prevention timer, as disclosed in FIG. 4. This new timer may be called an anti-ping-pong HO timer.

In addition the call processing component 140 may also be to prevent the handover based on a false breach of the fast handover performance threshold 250. For example, in an aspect of the present apparatus and methods, the new anti-ping-pong HO timer (i.e., ping-pong prevention timer, as disclosed in FIG. 4) will be started when UE 114 performs the handover into a new cell (i.e., when the last HO was completed, as disclosed in FIG. 4), so that the fast HO event should not be triggered before the new anti-ping-pong HO timer expires. As such, the anti-ping-pong HO timer can keep UE 114 in a new cell for at least a timer duration of the anti-ping-pong HO timer. The value of the timer duration of the anti-ping-pong HO timer can be referred to as a “time to trigger.”

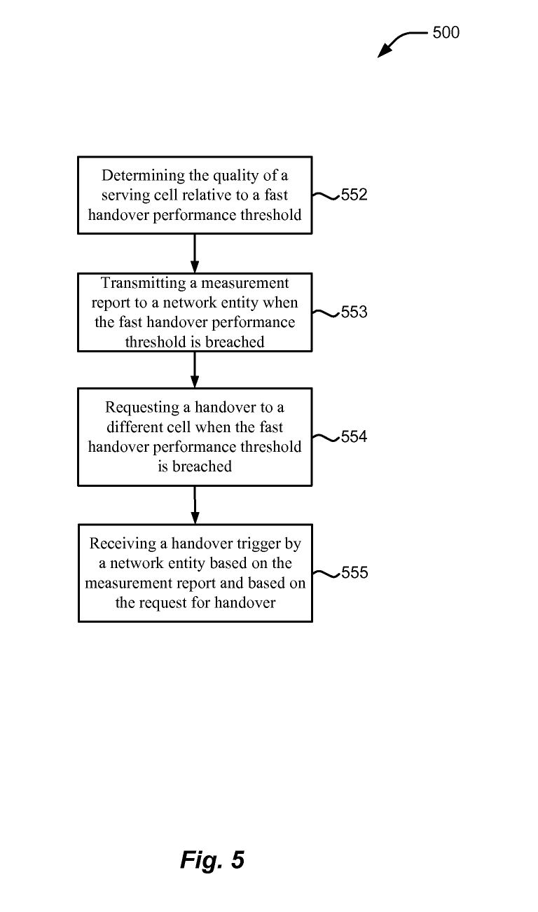

FIG. 5 is a flow diagram illustrating an exemplary method 500. At 552, as discussed above with reference to FIG. 2, call processing component 140 of UE 114 is configured for determining the quality of a serving cell relative to a fast handover performance threshold. For example, determining component 242, residing in the call processing component 140 of UE 114, is configured for determining the quality of a serving cell relative to a fast handover performance threshold 250.

At 553, as discussed above with reference to FIG. 2, call processing component 140 of UE 114 is configured for transmitting a measurement report when the fast handover performance threshold is breached. For example, after determining the quality of a serving cell relative to a fast handover performance threshold, transmitting component 243 is configured for transmitting a measurement report 252 to network 112 when the fast handover performance threshold 250 is breached.

At 554, as discussed above with reference to FIG. 2, call processing component 140 of UE 114 is configured for requesting a handover to a target cell when the fast handover performance threshold is breached. For example, after transmitting a measurement report when the fast handover performance threshold is breached, requesting component 244 is configured for requesting a handover to a target cell when the fast handover performance threshold 250 is breached.

At 555, as discussed above with reference to FIG. 2, call processing component 140 of UE 114 is configured for receiving a handover trigger based on the measurement report and based on the request for handover. For example, after requesting a handover to a target cell when the fast handover performance threshold is breached, receiving component 245 is configured for receiving a handover trigger 254 from network 112 based on measurement report 252 and based on the request for handover requested by requesting component 244.

In an aspect, for example, the executing method 500 may be UE 114 or network 112 (FIGS. 1 and 2) executing the call processing component 140 (FIGS. 1 and 2), or respective components thereof.

Thus, aspects of this apparatus and method include improving handover between a network and a UE when a measurement report is received.

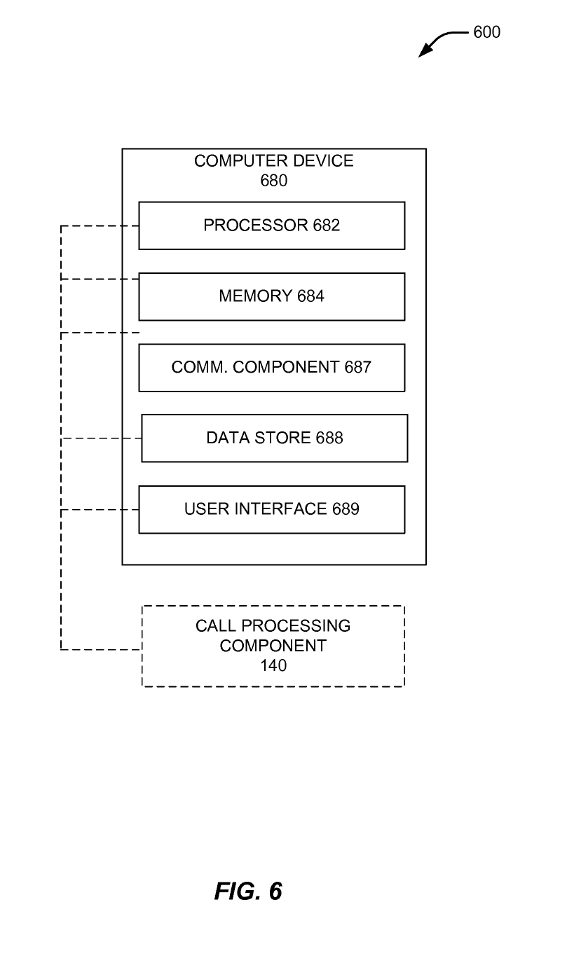

Referring to the computer system 600 of FIG. 6, in one aspect, UE 114 and/or wireless serving node 116 of FIGS. 1 and 2 may be represented by a specially programmed or configured computer device 680, wherein the special programming or configuration includes call processing component 140, as described herein. For example, for implementation as UE 114 (FIGS. 1 and 2), computer device 680 may include one or more components for computing and transmitting a data from a UE 114 to network 112 via wireless serving node 116, such as in specially programmed computer readable instructions or code, firmware, hardware, or some combination thereof. Computer device 680 includes a processor 682 for carrying out processing functions associated with one or more of components and functions described herein. Processor 682 can include a single or multiple set of processors or multi-core processors. Moreover, processor 682 can be implemented as an integrated processing system and/or a distributed processing system.

Computer device 680 further includes a memory 684, such as for storing data used herein and/or local versions of applications being executed by processor 682. Memory 684 can include any type of memory usable by a computer, such as random access memory (RAM), read only memory (ROM), tapes, magnetic discs, optical discs, volatile memory, non-volatile memory, and any combination thereof.

Further, computer device 680 includes a communications component 686 that provides for establishing and maintaining communications with one or more parties utilizing hardware, software, and services as described herein. Communications component 686 may carry communications between components on computer device 680, as well as between computer device 680 and external devices, such as devices located across a communications network and/or devices serially or locally connected to computer device 680. For example, communications component 686 may include one or more buses, and may further include transmit chain components and receive chain components associated with a transmitter and receiver, respectively, or a transceiver, operable for interfacing with external devices. For example, in an aspect, a receiver of communications component 686 operates to receive one or more data via a wireless serving node 116, which may be a part of memory 684.

Additionally, computer device 680 may further include a data store 688, which can be any suitable combination of hardware and/or software, that provides for mass storage of information, databases, and programs employed in connection with aspects described herein. For example, data store 688 may be a data repository for applications not currently being executed by processor 682.

Computer device 680 may additionally include a user interface component 689 operable to receive inputs from a user of computer device 680, and further operable to generate outputs for presentation to the user. User interface component 689 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof. Further, user interface component 689 may include one or more output devices, including but not limited to a display, a speaker, a haptic feedback mechanism, a printer, any other mechanism capable of presenting an output to a user, or any combination thereof.

Furthermore, computer device 680 may include, or may be in communication with, call processing component 140, which may be configured to perform the functions described herein.

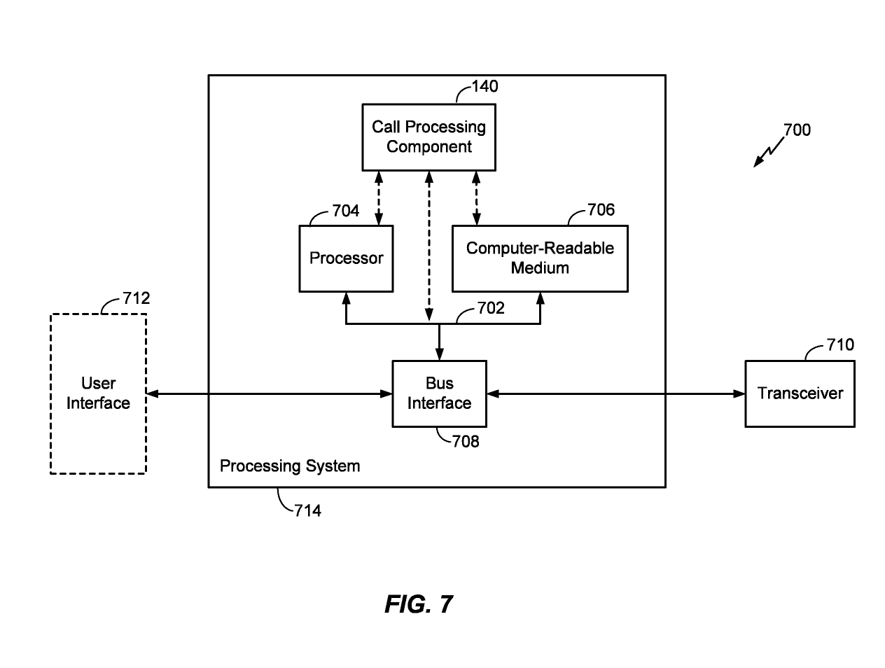

FIG. 7 is a block diagram illustrating an example of a hardware implementation for an apparatus 700 employing a processing system 714. Apparatus 700 may be configured to include, for example, wireless device 100 (FIGS. 1 and 2) and/or call processing component 140 (FIGS. 1 and 2) implementing the components described above, such as but not limited to determining component 242, transmitting component 243, requesting component 244, and receiving component 245. In this example, the processing system 714 may be implemented with a bus architecture, represented generally by the bus 702. The bus 702 may include any number of interconnecting buses and bridges depending on the specific application of the processing system 714 and the overall design constraints. The bus 702 links together various circuits including one or more processors, represented generally by the processor 704, and computer-readable media, represented generally by the computer-readable medium 706. The bus 702 may also link various other circuits such as timing sources, peripherals, voltage regulators, and power management circuits, which are well known in the art, and therefore, will not be described any further. A bus interface 708 provides an interface between the bus 702 and a transceiver 710. The transceiver 710 provides a means for communicating with various other apparatus over a transmission medium. Depending upon the nature of the apparatus, a user interface 712 (e.g., keypad, display, speaker, microphone, joystick) may also be provided.

The processor 704 is responsible for managing the bus 702 and general processing, including the execution of software stored on the computer-readable medium 706. The software, when executed by the processor 704, causes the processing system 714 to perform the various functions described infra for any particular apparatus. The computer-readable medium 706 may also be used for storing data that is manipulated by the processor 704 when executing software.

In an aspect, processor 704, computer-readable medium 706, or a combination of both may be configured or otherwise specially programmed to perform the functionality of the call processing component 140 (FIGS. 1 and 2) as described herein.

The various concepts presented throughout this disclosure may be implemented across a broad variety of telecommunication systems, network architectures, and communication standards.

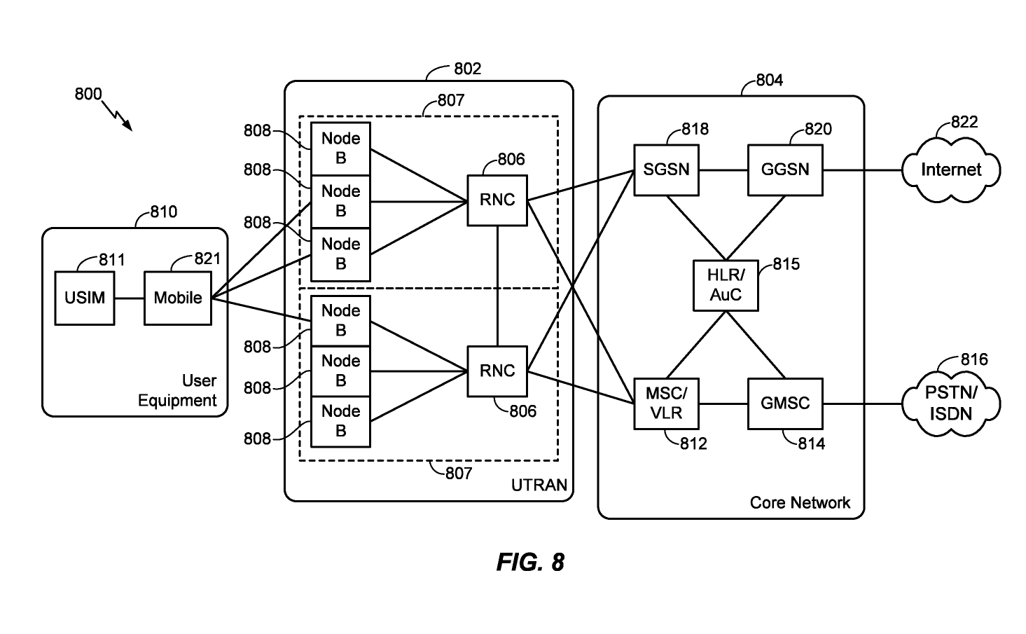

Referring to FIG. 8, by way of example and without limitation, the aspects of the present disclosure are presented with reference to a UMTS system 800 employing a W-CDMA air interface. A UMTS network includes three interacting domains: a Core Network (CN) 804, a UMTS Terrestrial Radio Access Network (UTRAN) 802, and User Equipment (UE) 810. UE 810 may be configured to include, for example, the call processing component 140 (FIGS. 1 and 2) implementing the components described above, such as but not limited to determining component 242, transmitting component 243, requesting component 244, and receiving component 245. In this example, the UTRAN 802 provides various wireless services including telephony, video, data, messaging, broadcasts, and/or other services. The UTRAN 802 may include a plurality of Radio Network Subsystems (RNSs) such as an RNS 807, each controlled by a respective Radio Network Controller (RNC) such as an RNC 806. Here, the UTRAN 802 may include any number of RNCs 806 and RNSs 807 in addition to the RNCs 806 and RNSs 807 illustrated herein. The RNC 806 is an apparatus responsible for, among other things, assigning, reconfiguring and releasing radio resources within the RNS 807. The RNC 806 may be interconnected to other RNCs (not shown) in the UTRAN 802 through various types of interfaces such as a direct physical connection, a virtual network, or the like, using any suitable transport network.

Communication between a UE 810 and a Node B 808 may be considered as including a physical (PHY) layer and a medium access control (MAC) layer. Further, communication between a UE 810 and an RNC 806 by way of a respective Node B 808 may be considered as including a radio resource control (RRC) layer. In the instant specification, the PHY layer may be considered layer 1; the MAC layer may be considered layer 2; and the RRC layer may be considered layer 3. Information hereinbelow utilizes terminology introduced in the RRC Protocol Specification, 3GPP TS 25.331, incorporated herein by reference.

The geographic region covered by the RNS 807 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 808 are shown in each RNS 807; however, the RNSs 807 may include any number of wireless Node Bs. The Node Bs 808 provide wireless access points to a CN 804 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The UE 810 is commonly referred to as a UE in UMTS applications, but may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. In a UMTS system, the UE 810 may further include a universal subscriber identity module (USIM) 811, which contains a user's subscription information to a network. For illustrative purposes, one UE 810 is shown in communication with a number of the Node Bs 808. The DL, also called the forward link, refers to the communication link from a Node B 808 to a UE 810, and the UL, also called the reverse link, refers to the communication link from a UE 810 to a Node B 808.

The CN 804 interfaces with one or more access networks, such as the UTRAN 802. As shown, the CN 804 is a GSM core network. However, as those skilled in the art will recognize, the various concepts presented throughout this disclosure may be implemented in a RAN, or other suitable access network, to provide UEs with access to types of CNs other than GSM networks.

The CN 804 includes a circuit-switched (CS) domain and a packet-switched (PS) domain.

Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the CN 804 supports circuit-switched services with a MSC 812 and a GMSC 814. In some applications, the GMSC 814 may be referred to as a media gateway (MGW). One or more RNCs, such as the RNC 806, may be connected to the MSC 812. The MSC 812 is an apparatus that controls call setup, call routing, and UE mobility functions. The MSC 812 also includes a VLR that contains subscriber-related information for the duration that a UE is in the coverage area of the MSC 812. The GMSC 814 provides a gateway through the MSC 812 for the UE to access a circuit-switched network 816. The GMSC 814 includes a home location register (HLR) 815 containing subscriber data, such as the data reflecting the details of the services to which a particular user has subscribed. The HLR is also associated with an authentication center (AuC) that contains subscriber-specific authentication data. When a call is received for a particular UE, the GMSC 814 queries the HLR 815 to determine the UE's location and forwards the call to the particular MSC serving that location.

The CN 804 also supports packet-data services with a serving GPRS support node (SGSN) 818 and a gateway GPRS support node (GGSN) 820. GPRS, which stands for General Packet Radio Service, is designed to provide packet-data services at speeds higher than those available with standard circuit-switched data services. The GGSN 820 provides a connection for the UTRAN 802 to a packet-based network 822. The packet-based network 822 may be the Internet, a private data network, or some other suitable packet-based network. The primary function of the GGSN 820 is to provide the UEs 810 with packet-based network connectivity. Data packets may be transferred between the GGSN 820 and the UEs 810 through the SGSN 818, which performs primarily the same functions in the packet-based domain as the MSC 812 performs in the circuit-switched domain.

An air interface for UMTS may utilize a spread spectrum Direct-Sequence Code Division Multiple Access (DS-CDMA) system. The spread spectrum DS-CDMA spreads user data through multiplication by a sequence of pseudorandom bits called chips. The “wideband” W-CDMA air interface for UMTS is based on such direct sequence spread spectrum technology and additionally calls for a frequency division duplexing (FDD). FDD uses a different carrier frequency for the UL and DL between a Node B 808 and a UE 810. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles may be equally applicable to a TD-SCDMA air interface.

An HSPA air interface includes a series of enhancements to the 3G/W-CDMA air interface, facilitating greater throughput and reduced latency. Among other modifications over prior releases, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink, or EUL).

HSDPA utilizes as its transport channel the high-speed downlink shared channel (HS-DSCH). The HS-DSCH is implemented by three physical channels: the high-speed physical downlink shared channel (HS-PDSCH), the high-speed shared control channel (HS-SCCH), and the high-speed dedicated physical control channel (HS-DPCCH).

Among these physical channels, the HS-DPCCH carries the HARQ ACK/NACK signaling on the uplink to indicate whether a corresponding packet transmission was decoded successfully. That is, with respect to the downlink, the UE 810 provides feedback to the node B 808 over the HS-DPCCH to indicate whether it correctly decoded a packet on the downlink.

HS-DPCCH further includes feedback signaling from the UE 810 to assist the node B 808 in taking the right decision in terms of modulation and coding scheme and precoding weight selection, this feedback signaling including the CQI and PCI.

“HSPA Evolved” or HSPA+ is an evolution of the HSPA standard that includes MIMO and 64-QAM, enabling increased throughput and higher performance. That is, in an aspect of the disclosure, the node B 808 and/or the UE 810 may have multiple antennas supporting MIMO technology. The use of MIMO technology enables the node B 808 to exploit the spatial domain to support spatial multiplexing, beamforming, and transmit diversity.

Multiple Input Multiple Output (MIMO) is a term generally used to refer to multi-antenna technology, that is, multiple transmit antennas (multiple inputs to the channel) and multiple receive antennas (multiple outputs from the channel). MIMO systems generally enhance data transmission performance, enabling diversity gains to reduce multipath fading and increase transmission quality, and spatial multiplexing gains to increase data throughput.

Spatial multiplexing may be used to transmit different streams of data simultaneously on the same frequency. The data steams may be transmitted to a single UE 810 to increase the data rate, or to multiple UEs 810 to increase the overall system capacity. This is achieved by spatially precoding each data stream and then transmitting each spatially precoded stream through a different transmit antenna on the downlink. The spatially precoded data streams arrive at the UE(s) 810 with different spatial signatures, which enables each of the UE(s) 810 to recover the one or more the data streams destined for that UE 810. On the uplink, each UE 810 may transmit one or more spatially precoded data streams, which enables the node B 808 to identify the source of each spatially precoded data stream.

Spatial multiplexing may be used when channel conditions are good. When channel conditions are less favorable, beamforming may be used to focus the transmission energy in one or more directions, or to improve transmission based on characteristics of the channel. This may be achieved by spatially precoding a data stream for transmission through multiple antennas. To achieve good coverage at the edges of the cell, a single stream beamforming transmission may be used in combination with transmit diversity.

Generally, for MIMO systems utilizing n transmit antennas, n transport blocks may be transmitted simultaneously over the same carrier utilizing the same channelization code. Note that the different transport blocks sent over the n transmit antennas may have the same or different modulation and coding schemes from one another.

On the other hand, Single Input Multiple Output (SIMO) generally refers to a system utilizing a single transmit antenna (a single input to the channel) and multiple receive antennas (multiple outputs from the channel). Thus, in a SIMO system, a single transport block is sent over the respective carrier.

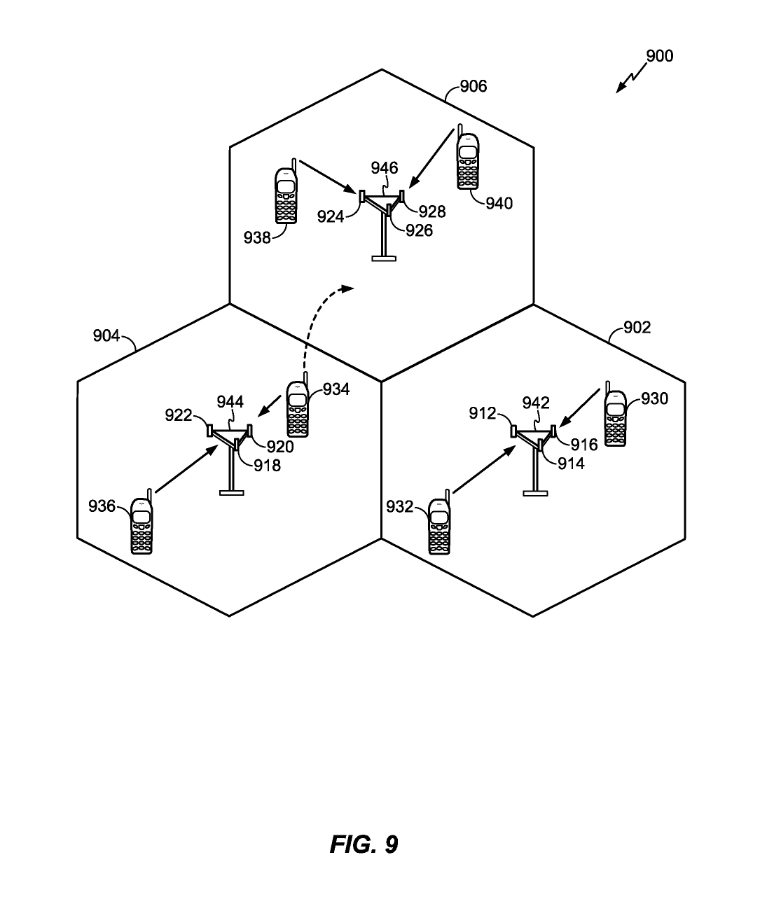

Referring to FIG. 9, an access network 900 in a UTRAN architecture is illustrated. The multiple access wireless communication system includes multiple cellular regions (cells), including cells 902, 904, and 906, each of which may include one or more sectors. The multiple sectors can be formed by groups of antennas with each antenna responsible for communication with UEs in a portion of the cell. For example, in cell 902, antenna groups 912, 914, and 916 may each correspond to a different sector. In cell 904, antenna groups 918, 920, and 922 each correspond to a different sector. In cell 906, antenna groups 924, 926, and 928 each correspond to a different sector. The cells 902, 904 and 906 may include several wireless communication devices, e.g., User Equipment or UEs, which may be in communication with one or more sectors of each cell 902, 904 or 906. For example, UEs 930 and 932 may be in communication with Node B 942, UEs 934 and 936 may be in communication with Node B 944, and UEs 938 and 940 can be in communication with Node B 946. Here, each Node B 942, 944, 946 is configured to provide an access point to a CN 904 (see FIG. 9) for all the UEs 930, 932, 934, 936, 938, 940 in the respective cells 902, 904, and 906. Node Bs 942, 944, 946 and UEs 930, 932, 934, 936, 938, 940 respectively may be configured to include, for example, the call processing component 140 (FIGS. 1 and 2) implementing the components described above, such as but not limited to determining component 242, transmitting component 243, requesting component 244, and receiving component 245.

As the UE 934 moves from the illustrated location in cell 904 into cell 906, a serving cell change (SCC) or handover may occur in which communication with the UE 934 transitions from the cell 904, which may be referred to as the source cell, to cell 906, which may be referred to as the target cell. Management of the handover procedure may take place at the UE 934, at the Node Bs corresponding to the respective cells, at a radio network controller 806 (see FIG. 8), or at another suitable node in the wireless network. For example, during a call with the source cell 904, or at any other time, the UE 934 may monitor various parameters of the source cell 904 as well as various parameters of neighboring cells such as cells 906 and 902. Further, depending on the quality of these parameters, the UE 934 may maintain communication with one or more of the neighboring cells. During this time, the UE 934 may maintain an Active Set, that is, a list of cells that the UE 934 is simultaneously connected to (i.e., the UTRA cells that are currently assigning a downlink dedicated physical channel DPCH or fractional downlink dedicated physical channel F-DPCH to the UE 934 may constitute the Active Set).

The modulation and multiple access scheme employed by the access network 900 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), and Flash-OFDM employing OFDMA. CDMA2000 and UMB are described in documents from the 3GPP2 organization. The actual wireless communication standard and the multiple access technology employed will depend on the specific application and the overall design constraints imposed on the system.

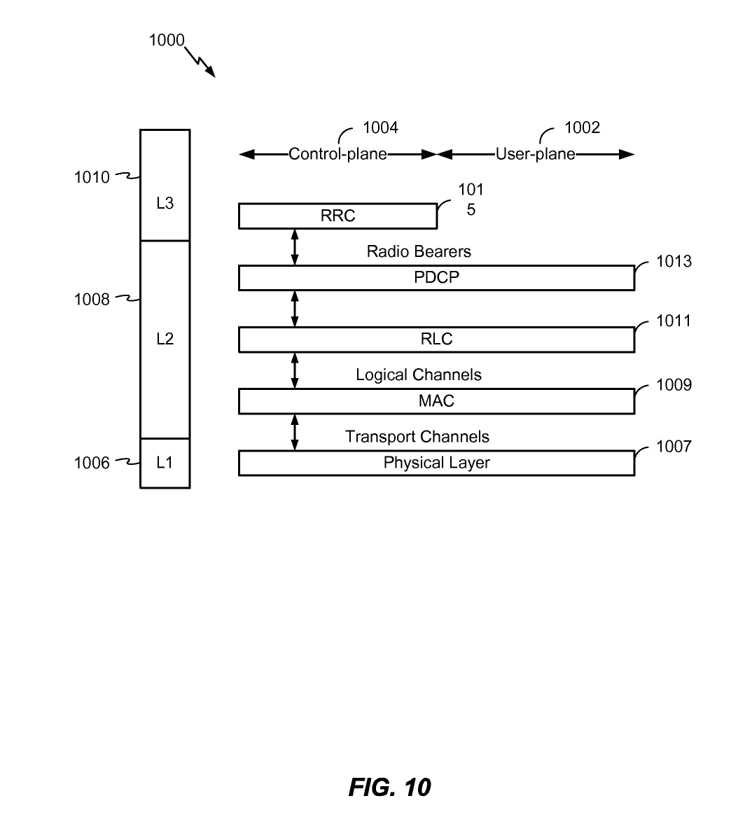

The radio protocol architecture may take on various forms depending on the particular application. An example for an HSPA system will now be presented with reference to FIG. 10.

FIG. 10 is a conceptual diagram illustrating an example of the radio protocol architecture 1000 for the user plane 1002 and the control plane 1004 of a user equipment (UE) or node B/base station. For example, architecture 1000 may be included in a network entity and/or UE such as an entity within wireless network 112 and/or UE 114 (FIGS. 1 and 2). The radio protocol architecture 1000 for the UE and node B is shown with three layers: Layer 1 1006, Layer 2 1008, and Layer 3 1010. Layer 1 1006 is the lowest lower and implements various physical layer signal processing functions. As such, Layer 1 1006 includes the physical layer 1007. Layer 2 (L2 layer) 1008 is above the physical layer 1007 and is responsible for the link between the UE and node B over the physical layer 1007. Layer 3 (L3 layer) 1010 includes a radio resource control (RRC) sublayer 1015. The RRC sublayer 1015 handles the control plane signaling of Layer 3 between the UE and the UTRAN.

In the user plane, the L2 layer 1008 includes a media access control (MAC) sublayer 1009, a radio link control (RLC) sublayer 1011, and a packet data convergence protocol (PDCP) 1013 sublayer, which are terminated at the node B on the network side. Although not shown, the UE may have several upper layers above the L2 layer 1008 including a network layer (e.g., IP layer) that is terminated at a PDN gateway on the network side, and an application layer that is terminated at the other end of the connection (e.g., far end UE, server, etc.).

The PDCP sublayer 1013 provides multiplexing between different radio bearers and logical channels. The PDCP sublayer 1013 also provides header compression for upper layer data packets to reduce radio transmission overhead, security by ciphering the data packets, and handover support for UEs between node Bs. The RLC sublayer 1011 provides segmentation and reassembly of upper layer data packets, retransmission of lost data packets, and reordering of data packets to compensate for out-of-order reception due to hybrid automatic repeat request (HARQ). The MAC sublayer 1009 provides multiplexing between logical and transport channels. The MAC sublayer 1009 is also responsible for allocating the various radio resources (e.g., resource blocks) in one cell among the UEs. The MAC sublayer 1009 is also responsible for HARQ operations.

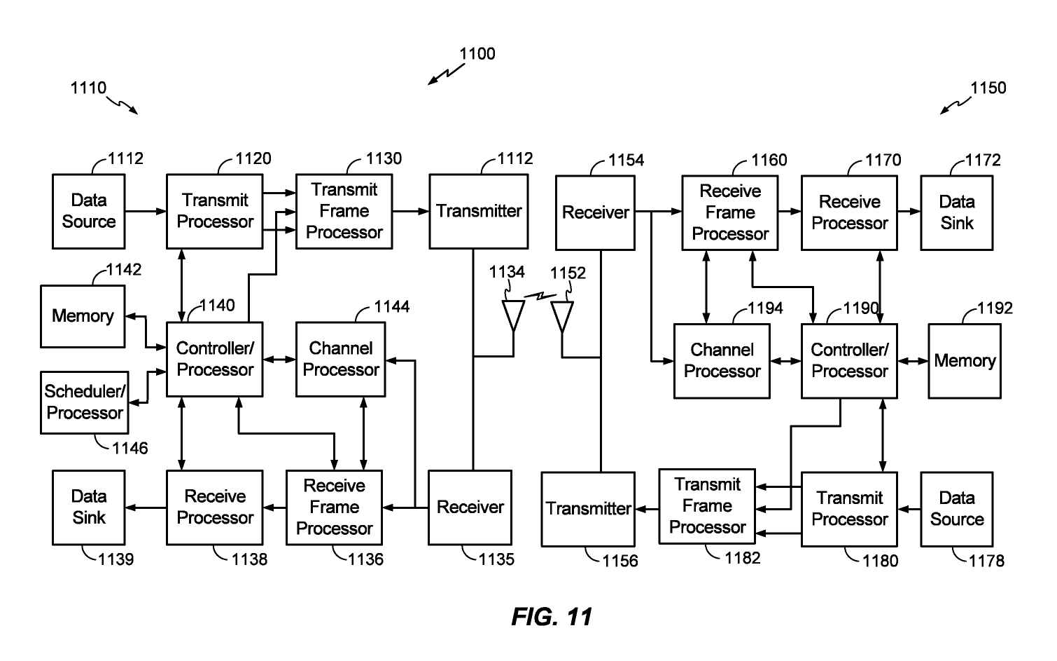

FIG. 11 is a block diagram of a communication system 1100 including a Node B 1110 in communication with a UE 1150, where Node B 1110 may be an entity within network 112 and the UE 1150 may be UE 114 according to the aspect described in FIGS. 1 and 2. In the downlink communication, a transmit processor 1120 may receive data from a data source 1112 and control signals from a controller/processor 1140. The transmit processor 1120 provides various signal processing functions for the data and control signals, as well as reference signals (e.g., pilot signals). For example, the transmit processor 1120 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 1144 may be used by a controller/processor 1140 to determine the coding, modulation, spreading, and/or scrambling schemes for the transmit processor 1120. These channel estimates may be derived from a reference signal transmitted by the UE 1150 or from feedback from the UE 1150. The symbols generated by the transmit processor 1120 are provided to a transmit frame processor 1130 to create a frame structure. The transmit frame processor 1130 creates this frame structure by multiplexing the symbols with information from the controller/processor 1140, resulting in a series of frames. The frames are then provided to a transmitter 1132, which provides various signal conditioning functions including amplifying, filtering, and modulating the frames onto a carrier for downlink transmission over the wireless medium through antenna 1134. The antenna 1134 may include one or more antennas, for example, including beam steering bidirectional adaptive antenna arrays or other similar beam technologies.

At the UE 1150, a receiver 1154 receives the downlink transmission through an antenna 1152 and processes the transmission to recover the information modulated onto the carrier. The information recovered by the receiver 1154 is provided to a receive frame processor 1160, which parses each frame, and provides information from the frames to a channel processor 1194 and the data, control, and reference signals to a receive processor 1170. The receive processor 1170 then performs the inverse of the processing performed by the transmit processor 1120 in the Node B 1110. More specifically, the receive processor 1170 descrambles and despreads the symbols, and then determines the most likely signal constellation points transmitted by the Node B 1110 based on the modulation scheme. These soft decisions may be based on channel estimates computed by the channel processor 1194. The soft decisions are then decoded and deinterleaved to recover the data, control, and reference signals. The CRC codes are then checked to determine whether the frames were successfully decoded. The data carried by the successfully decoded frames will then be provided to a data sink 1172, which represents applications running in the UE 1150 and/or various user interfaces (e.g., display). Control signals carried by successfully decoded frames will be provided to a controller/processor 1190. When frames are unsuccessfully decoded by the receiver processor 1170, the controller/processor 1190 may also use an acknowledgement (ACK) and/or negative acknowledgement (NACK) protocol to support retransmission requests for those frames.

In the uplink, data from a data source 1178 and control signals from the controller/processor 1190 are provided to a transmit processor 1180. The data source 1178 may represent applications running in the UE 1150 and various user interfaces (e.g., keyboard). Similar to the functionality described in connection with the downlink transmission by the Node B 1110, the transmit processor 1180 provides various signal processing functions including CRC codes, coding and interleaving to facilitate FEC, mapping to signal constellations, spreading with OVSFs, and scrambling to produce a series of symbols. Channel estimates, derived by the channel processor 1194 from a reference signal transmitted by the Node B 1110 or from feedback contained in the midamble transmitted by the Node B 1110, may be used to select the appropriate coding, modulation, spreading, and/or scrambling schemes. The symbols produced by the transmit processor 1180 will be provided to a transmit frame processor 1182 to create a frame structure. The transmit frame processor 1182 creates this frame structure by multiplexing the symbols with information from the controller/processor 1190, resulting in a series of frames. The frames are then provided to a transmitter 1156, which provides various signal conditioning functions including amplification, filtering, and modulating the frames onto a carrier for uplink transmission over the wireless medium through the antenna 1152.

The uplink transmission is processed at the Node B 1110 in a manner similar to that described in connection with the receiver function at the UE 1150. A receiver 1135 receives the uplink transmission through the antenna 1134 and processes the transmission to recover the information modulated onto the carrier. The information recovered by the receiver 1135 is provided to a receive frame processor 1136, which parses each frame, and provides information from the frames to the channel processor 1144 and the data, control, and reference signals to a receive processor 1138. The receive processor 1138 performs the inverse of the processing performed by the transmit processor 1180 in the UE 1150. The data and control signals carried by the successfully decoded frames may then be provided to a data sink 1139 and the controller/processor, respectively. If some of the frames were unsuccessfully decoded by the receive processor, the controller/processor 1140 may also use an acknowledgement (ACK) and/or negative acknowledgement (NACK) protocol to support retransmission requests for those frames.

The controller/processors 1140 and 1190 may be used to direct the operation at the Node B 1110 and the UE 1150, respectively. For example, the controller/processors 1140 and 1190 may provide various functions including timing, peripheral interfaces, voltage regulation, power management, and other control functions. The computer readable media of memories 1142 and 1192 may store data and software for the Node B 1110 and the UE 1150, respectively. A scheduler/processor 1146 at the Node B 1110 may be used to allocate resources to the UEs and schedule downlink and/or uplink transmissions for the UEs.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” or processor (FIG. 6 or 7) that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 706 (FIG. 7). The computer-readable medium 706 (FIG. 7) may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
determining the quality of a serving cell relative to a fast handover performance threshold;
transmitting a measurement report when the fast handover performance threshold is breached;
requesting a handover to a target cell when the fast handover performance threshold is breached; and
receiving a handover trigger based on the measurement report and based on the request for handover.

2. The method of claim 1, further comprising preventing handover based on a false breach of the fast handover performance threshold.

3. The method of claim 1, wherein the fast handover performance threshold is a signal quality based metric

4. The method of claim 1, wherein the fast handover performance threshold is a path loss based metric.

5. The method of claim 1, wherein the fast handover performance threshold is an interference based metric.

6. The method of claim 1, wherein the fast handover performance threshold is a transmission power based metric.

7. The method of claim 1, wherein the fast handover performance threshold is based on abrupt call quality variations during the time to trigger (TTT) period such that the TTT is skipped.

8. The method of claim 1, wherein a source cell is exempt from the fast handover performance threshold until the next handover trigger.

9. The method of claim 1, wherein the measurement report includes including information relating to a measured quality of a serving cell and one or more target cells.

10. The method of claim 1, wherein transmitting the measurement event report is triggered based on a velocity of decrease in a received signal code power (RSCP) of a serving cell.

11. The method of claim 1, further comprising employing an anti-ping-pong timer to prevent handover based on a false breach of the fast handover performance threshold.

12. An apparatus of wireless communication, comprising:
at least one processor; and
a memory coupled to the at least one processor, wherein the at least one processor is configured to:
determine the quality of a serving cell relative to a fast handover performance threshold;
transmit a measurement report when the fast handover performance threshold is breached;
request a handover to a target cell when the fast handover performance threshold is breached; and
receive a handover trigger based on the measurement report and based on the request for handover.

13. The apparatus of claim 12, wherein the at least one processor is further configured to prevent handover based on a false breach of the fast handover performance threshold.

14. The apparatus of claim 12, wherein the fast handover performance threshold is a signal quality based metric

15. The apparatus of claim 12, wherein the fast handover performance threshold is a path loss based metric.

16. The apparatus of claim 12, wherein the fast handover performance threshold is an interference based metric.

17. The apparatus of claim 12, wherein the fast handover performance threshold is a transmission power based metric.

18. The apparatus of claim 12, wherein the fast handover performance threshold is based on abrupt call quality variations during the time to trigger (TTT) period such that the TTT is skipped.

19. The apparatus of claim 12, wherein a source cell is exempt from the fast handover performance threshold until the next handover trigger.

20. The apparatus of claim 12, wherein the measurement report includes including information relating to a measured quality of a serving cell and one or more target cells.

21. The apparatus of claim 12, wherein transmitting the measurement event report is triggered based on a velocity of decrease in a received signal code power (RSCP) of a serving cell.

22. The apparatus of claim 12, wherein the at least one processor is further configured to employ an anti-ping-pong timer to prevent handover based on a false breach of the fast handover performance threshold.

23. An apparatus of wireless communication, comprising:
means for determining the quality of a serving cell relative to a fast handover performance threshold;
means for transmitting a measurement report when the fast handover performance threshold is breached;
means for requesting a handover to a target cell when the fast handover performance threshold is breached; and
means for receiving a handover trigger based on the measurement report and based on the request for handover.

24. A computer program product stored on a computer readable medium, comprising code for:
determining the quality of a serving cell relative to a fast handover performance threshold;
transmitting a measurement report when the fast handover performance threshold is breached;
requesting a handover to a target cell when the fast handover performance threshold is breached; and
receiving a handover trigger based on the measurement report and based on the request for handover.
